(19) United States
(12) Patent Application Publication
(10) Pub. No.: US 2022/0309559 A1
(43) Pub. Date: Sep. 29, 2022

(54) SYSTEM AND METHODS FOR PROVIDING SAMPLES TO CUSTOMERS IN AN ONLINE ENVIRONMENT

(71) Applicant: Walmart Apollo, LLC, Bentonville, AR (US)

(72) Inventors: Chittaranjan Tripathy, Sunnyvale, CA (US); Karan Khurana, Foster City, CA (US); Ioannis Pavlidis, Boulder, CO (US)

(21) Appl. No.: 17/615,802

(22) PCT Filed: Jun. 2, 2020
(86) PCT No.: PCT/US2020/035722

§ 371 Date: Dec. 1, 2021

Related U.S. Application Data
(60) Provisional application No. 62/856,199, filed on Jun. 3, 2019.
(60) Provisional application No. 62/856,242, filed on Jun. 3, 2019.
(60) Provisional application No. 62/856,253, filed on Jun. 3, 2019.

(51) Int. Cl. G06Q 30/06

(52) U.S. Cl. CPC G06Q 30/0631; G06Q 30/0605; G06Q 30/0633

(57) ABSTRACT

In some embodiments, apparatuses and methods are provided herein useful to providing personalized samples to customers. In some embodiments, a system for providing personalized samples to customers comprises an online shopping server configured to host an online shopping website and receive item selections indicating items to add to the customer's cart, a database configured to store a list of sample types, and a purchase likelihood estimator configured to receive the items to add to the customer's cart, determine an identity of the customer, determine customer traits, determine available sample types and traits associated with the available sample types, calculate a probability score based on the customer traits and the traits associated with each of the available sample types, and add, to the customer's cart based on the probability scores for each of the available sample types, one or more samples from the one or more of the available sample types.

### CROSS-REFERENCE TO RELATED APPLICATION

This application claims the benefit of U.S. Provisional Application No. 62/856,199, filed Jun. 3, 2019, U.S. Provisional Application No. 62/856,242, filed Jun. 3, 2019, and U.S. Provisional Application No. 62/856,253, filed Jun. 3, 2019, which are all incorporated by reference in their entirety herein.

### TECHNICAL FIELD

This invention relates generally to online shopping and, more particularly, to online shopping websites.

### BACKGROUND

Some retailers offer samples to customers at brick-and-mortar facilities. Typically, retailers offer samples to customer free of charge in hopes that the customer will enjoy the item and ultimately purchase the item. For example, a retailer may offer samples of a food item to customers as the customers shop. While providing samples to customers may result in sales of the items offered, this technique is only useful for customers in a brick-and-mortar facility. Additionally, these samples are not targeted but rather are provided to customers at large.

In addition to providing samples in-store (e.g., in a brick-and-mortar facility), some retailers provide samples to customers via mail. For example, a retailer or other business can mail samples to customers. While this method of providing samples does not require a customer to physically enter a retail facility, the technique by which the samples are provided is often crude. For example, the samples may be provided based on the customer's geographic location or fact that the customer has previously shopped with the retailer, but this distribution does not take into account the likelihood that a customer will ultimately purchase the item for which the sample is offered. Consequently, a need exists for sample distribution techniques that can more accurately provide samples to customer that may actually purchase the item for which the samples are provided.

### BRIEF DESCRIPTION OF THE DRAWINGS

Disclosed herein are embodiments of systems, apparatuses, and methods pertaining providing personalized samples to a customer. This description includes drawings, wherein:

FIG. 1 depicts a web browser 100 presenting a customer's cart 102 including samples selected for the customer, according to some embodiments:

FIG. 2 depicts a web browser 200 presenting a customer's cart 202 and a sample selection 214, according to some embodiments;

FIG. 3 is a block diagram of a system 300 for providing personalized samples to customers, according to some embodiments;

FIG. 4 is a flow chart including example operations for providing personalized samples to customers, according to some embodiments;

FIG. 5 is a flow chart including example operations for providing personalized samples to customers, according to some embodiments;

FIG. 6 is a flow chart including example operations for providing personalized samples to customers, according to some embodiments; and

FIG. 7 is a bipartite graph 700, according to some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein useful to providing personalized samples to customers. In some embodiments, a system for providing personalized samples to customers comprises an online shopping server, wherein the online shopping server is configured to host an online shopping website and receive, from a customer, item selections, wherein the item selections indicate items to add to the customer's cart, a database, wherein the database is configured to store a list of sample types, and a purchase likelihood estimator communicatively coupled to the online shopping server, the purchase likelihood estimator configured to receive, from the online shopping server, the items to add to the customer's cart, determine an identity of the customer, determine, based on the identity of the customer, customer traits, wherein the customer traits are based on one or more of the customer's purchase history, the customer's browsing history, and the items to add to the customer's cart, determine, based on accessing the database, available sample types and traits associated with the available sample types, calculate, for each of the available sample types, a probability score, wherein the probability score is based on the customer traits and the traits associated with each of the available sample types, and wherein the probability score indicates a likelihood that the customer will purchase an item of each of the available sample types, and add, to the customer's cart based on the probability scores for each of the available sample types, one or more samples from the one or more of the available sample types.

As previously discussed, providing free samples to customers may increase sales for a retailer. Specifically, when a customer receives the sample, he or she may enjoy the item and decide to purchase the item. However, providing samples in an untargeted manner results in inefficiencies. For example, if a retailer provides samples of dog food to all customers, those customers that do not have dogs are unlikely to ultimately purchase the product. Additionally, even if the samples are targeted, the targeting is often rudimentary. For example, the samples may be provided to customers based only on their geographic location (e.g., all persons within a specified distance to a retailer) or to all customers that have previously shopped at a retail facility. While these targeted samples may have a greater chance of resulting in a purchase than untargeted samples, the targeted sample distribution technique fails to consider the likelihood that a customer will actually purchase the item (e.g., based on the learned similarities between products and customers, and their interactions therewith).

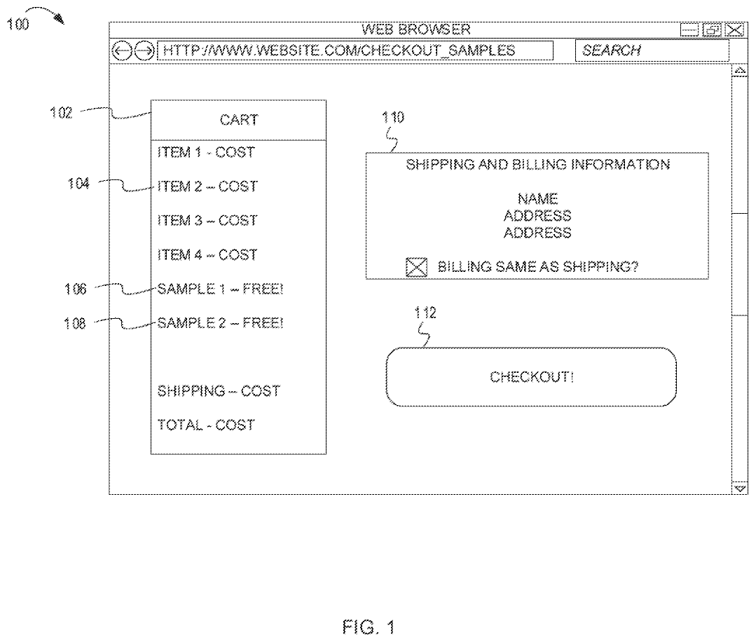

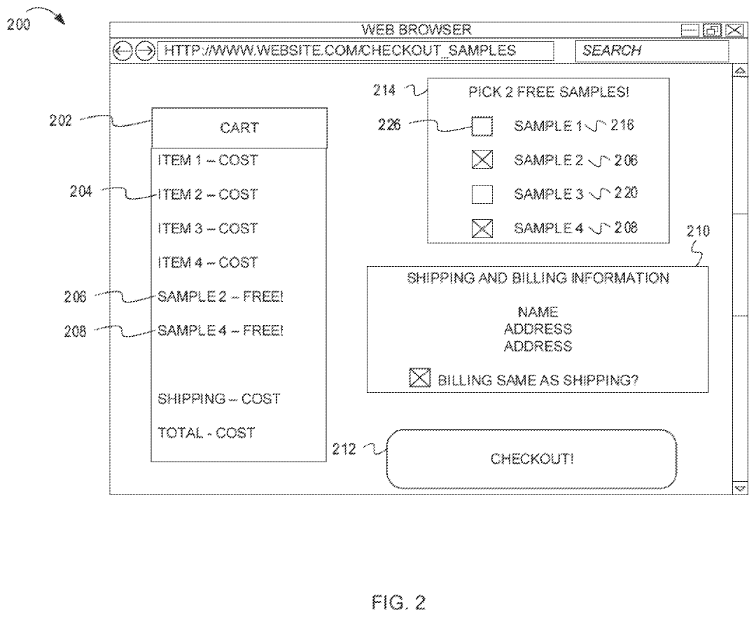

Described herein are systems, methods, and apparatuses that seek to overcome some of the drawbacks of providing samples to customers. For example, in some embodiments, samples are provided to customers based on the customer's likelihood of purchasing an item of the sample. The likelihood that the customer will ultimately purchase the product is determined based on a probability score. The probability score is calculated based on customer traits and traits associated with the samples. The samples are then provided to customers based on the probability scores. Additionally, in some embodiments, the system can intelligently distribute a limited number of samples amongst customers. In such embodiments, the system calculates, based on the probability scores, the distribution of the samples that will result in maximum customer satisfaction (e.g., over the population of customers). Further, in some embodiments, the system can allow customers to select from a list of available samples. In such embodiments, the system selects, for example, four samples for a customer based on the probability scores. The customer is then provided with an offer to select, for example, two of the four samples provided. The discussions of FIG. 1 and FIG. 2 provide background information for a system for providing samples to customers based on probability scores.

FIG. 1 depicts a web browser 100 presenting a customer's cart 102 including samples selected for the customer, according to some embodiments. The customer's cart includes four items 104 (i.e., Item₁, Item₂, Item₃, and Item₄). Each of the items 104 had been selected by a customer while the customer shopped on an online shopping website. That is, while shopping, the customer selected items (i.e., made item selections) to add to his or her cart. The cart 102 includes the items 104 as well as prices associated with each of the items 104.

The cart 102 also includes two samples. Sample₁ 106 and Sample₂ 108. The samples are provided to the customer free of charge (e.g., the samples can be provided by the retailer, a supplier, manufacturer, etc.). Though the cart 102 depicted in FIG. 1 includes samples provided to the customer free of charge, in some embodiments, the customer may be charged a fee for the samples (e.g., shipping charges or a nominal fee to receive the samples). The web browser 100 includes a section 110 for shipping and billing information and a checkout selection 112. It should be noted that, in some embodiments, receipt of the samples is optional (e.g., the customer can opt out of receiving samples before shopping, while shopping, when samples are presented, etc.). For example, the customer may decline one or more of the samples provided. If the customer indicates that he or she does not want one or more of the samples, the one or more of the samples that the customer does not want are removed from the customer's cart 102. In the case where the customer has opted out before the samples are provided (e.g., before shopping or while shopping), no samples are added to the customer's cart 102.

The samples are selected for the customer based on information known about the customer. The information about the customer can be derived from online and/or in-store shopping data. The online shopping data can include any data that can be gathered from a customer's interaction with a retailer's website and/or other websites, such as, for example, purchase histories and browsing histories. The in-store shopping data can be obtained through devices carried by the customer, devices in the customer's home, and/or devices in the store (e.g., internet of things (“IoT”) devices). For example, a retail facility can include different types of image capture devices, sensors, etc. that monitor shopping trends in the retail facility (e.g., where the customer travels, what the customer looks at, the products with which the customer interacts, etc.). For example, location data from a customer's mobile device can be used, with prior permission, to track the customer as the customer traverses the retail facility. Additionally, or alternatively, devices within the customer's home can include IoT devices. For example, the customer's refrigerator, pantry, etc. can include weight and/or image sensors that monitor the items and/or quantity of items that the customer possesses. In some embodiments, the system can also monitor consumption rates and trends. Additionally, in some embodiments, customers may be able to influence the samples with which they are presented. For example, in some embodiments, a customer can select sample types that he or she would like to receive and/or avoid receiving. This selection can occur before the samples are presented or while the samples are being presented. For example, in one embodiment, the customers can set preferences in their profiles related to the types of samples that they would like to receive and/or avoid receiving. Additionally, or alternatively, at the time a sample is presented to a customer, he or she can indicate that he or she likes or dislikes the sample. This information can be stored in association with the customer and used for later sample selections for the customer.

FIG. 2 depicts a web browser 200 presenting a customer's cart 202 and a sample selection 214, according to some embodiments. Like FIG. 1, FIG. 2 includes a customer's cart 202 with four items 204. The cart 202 also includes two samples: Sample₂ 206 and Sample₄ 208. The customer has selected these samples from the sample selection 214. The sample selection 214 presents four sample (i.e., Sample₁ 216, Sample₂ 206, Sample₃ 220, and Sample₄ 208). Each of the four samples has an associated selection box 226. The customer is presented with the option of selecting two of the four offered samples. As depicted in FIG. 2, the customer has selected Sample₂ 206 and Sample₄ 208, as indicated by the marking on the selection boxes 226 associated with Sample₂ 206 and Sample₄ 208 and the addition of Sample₂ 206 and Sample₄ 208 to the customer's cart 202. The web browser 200 includes a section 210 for shipping and billing information and a checkout selection 212.

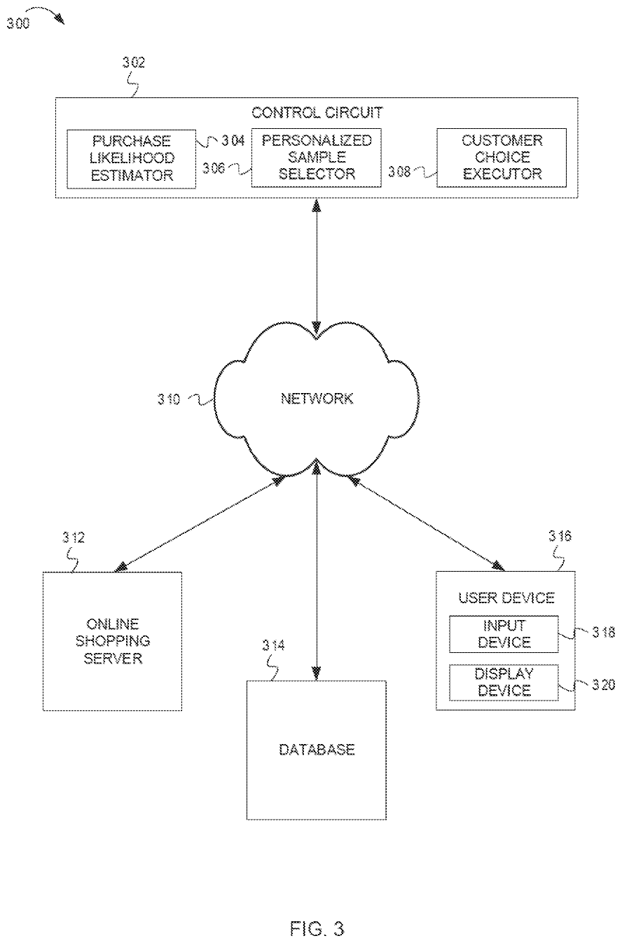

While the discussion of FIGS. 1 and 2 provides background information for a system for providing samples to customers based on probability scores, the discussion of FIG. 3 provides details regarding such a system.

FIG. 3 is a block diagram of a system 300 for providing personalized samples to customers, according to some embodiments. The system 300 includes a control circuit 302, a network 310, an online shopping server 312, a database 314, and a user device 316. At least some of the control circuit 302, online shopping server 312, database 314, and user device 316 are communicatively coupled via the network 310. Accordingly, the network 310 can be of any suitable type, such as a local area network (LAN) and/or wide area network (WAN), such as the Internet. The network 310 can include both wired and wireless links. The control circuit 302 includes a purchase likelihood estimator (“PLE”) 304, a personalized sample selector (“PSS”) 306, and a customer choice executor (“CCE”) 308. Though depicted in FIG. 3 as residing within a single device (i.e., the control circuit 302), one or more of the purchase likelihood estimator 304, the personalized sample selector 306, and the customer choice executor 308 can be separate components. Additionally, FIG. 3 depicts the purchase likelihood estimator 304, the personalized sample selector 306, and the customer choice executor 308 as being separate modules, embodiments are not so limited. For example, the control circuit 302 can perform the operations of the purchase likelihood estimator 304, the personalized sample selector 306, and the customer choice executor 308 without having separate modules, code sets, etc. for each of the purchase likelihood estimator 304, the personalized sample selector 306, and the customer choice executor 308.

The online shopping server 312 is configured to host an online shopping website. The online shopping website can be associated with a single retailer, multiple retailers, allow third party sellers, etc. The online shopping website allows customers to purchase products, for example, as depicted in FIGS. 1 and 2. The online shopping website is presented to a user via a display device 320 of the user device 316. The presentation of the online shopping website can be via a browser (e.g., as depicted in FIGS. 1 and 2) or an application (e.g., an application specific to the online shopping website). The user can navigate the online shopping website and select items via a user input device (i.e., providing a user interface) 318 of the user device 316. The user device 316 can be of any suitable type, such as a computer, a smart phone, a tablet, an automotive infotainment system, etc. Though depicted as separate devices (e.g., a monitor and a keyboard), the display device 320 and the user input device 318 can be integrated into a single component (e.g., a touchscreen).

The database 314 is configured to store a list of sample types. The database 314 can be configured in any suitable manner (e.g., a relational database, SQL database, NOSQL database, etc.). Accordingly, the database 314 can be arranged in any suitable manner. The list of sample types can include the type of the sample type as well as other traits associated with the samples, such as the quantity of the sample, the cost of the sample, the availability of the sample, the category of the sample, or any other desired characteristic of the samples. In some embodiments, the database 314 also includes customer traits. For example, the customer traits can include customer identifiers (e.g., customer numbers), customer identities (e.g., names of customers), customer information (e.g., customer addresses, demographics, associations, etc.), customer purchase histories, customer browsing histories, etc.

The control circuit 302 is in communication with the database 314 and the online shopping server 312. The control circuit 302 receives, from the online shopping server 312, items to add to a customer's cart and, from the database 314, available sample types and traits associated with the available sample types. The control circuit 302 generally selects samples for the customers. In one embodiment, the purchase likelihood estimator 304 calculates probability scores for each of the available sample types for the customer. The probability scores are based on the customer traits and traits associated with the available sample types. The probability scores indicate the likelihood that the customer will purchase an item of each of the sample types. The purchase likelihood estimator 304 can calculate the probability scores based on a variety of approaches, such as penalized-logistic regression models, gradient boosting, random forest, feed-forward neural network models, etc.

As one example, the purchase likelihood estimator 304 calculates probability scores based on a customer's traits (e.g., customer traits based on the customer's purchase history, browsing history, and items to add to the customer's cart). In this example, the customer's traits can be expressed by the vector—

x=xₚₕ,x_{br},x_{ct},xᵢₙ,xₑₓ,

where xₚₕ is the slice of the vector x representing the covariates for the customer's purchase history, x_{br} is the slice of the vector x representing the covariates for the customer's browsing history, x_{ct} is the slice of the vector x representing the customer's cart (i.e., items to add to the customer's cart), xᵢₙ, is the slice of vector x representing the covariates of the customer's in-store purchase and time spent in-store (e.g., derived from data provided by a mobile device carried by a customer), and xₑₓ, is the slice of vector x representing the covariates for the customer's location (e.g., derived from location serviced of a mobile device carried by the customer. It should be noted that, in some embodiments, greater or fewer vector slices are present.

In this example, the vectors x, xₚₕ, x_{br}, x_{ct}, xᵢₙ, and xₑₓ are vector of dimensions d, dₚₕ, d_{br}, d_{ct}, dᵢₙ and dₑₓ, respectively, and—

d=dₚₕ+d_{br}+d_{ct}+dᵢₙ+dₑₓ.

The purchase likelihood estimator 304 considers whether the customer will buy a particular item. Since the customer will either buy the item or not buy the item, the purchase of the item can be represented by Boolean value (i.e., B=1 if the customer buys the item and B=0 if the customer does not buy the item.) Accordingly, the probability score, representing the probability that the customer will buy the item given the customer's trait vector x, is defined as the conditional probability of B=1 given the vector x, that is—

Probability Score(x)=Pr(B=1|X=x).

In this equation, X is a random vector representing a customer via vector x of observed covariates (e.g., the customer traits, as described above).

Using n such customer's traits, represented by an n×d matrix and corresponding buys Bᵢ, wherein 1≤i≤n represented by an n dimensional vector, the purchase likelihood estimator 304 utilizes a learning model M to calculate portability scores for customers based on items. Assume that the purchase likelihood estimator 304 is calculating the probability score that Customerₓ will purchase Item_{y} and that Customerₓ is represented by a vector X_{Customer}_{ₓ}, the customer's probability (p_{Customer}_{ₓ}) of buying Item_{y} is given by—

p_{Customer}_{ₓ}=M(X_{Customer}_{ₓ}).

The probability p_{Customer}_{ₓ} represents a vector of probabilities for each customer for each item. For example, if there are m items in a sample set, the learning model M generates a vector of m probabilities for each item for a given customer.

Given the customer's probability of purchasing Item_{y}, as denoted above as one example, the purchase likelihood estimator 304, using for example, logistic regression models the probability of Customerₓ purchasing Item_{y} as—

$$log \frac{p ( x )}{1 - p ( x )} = {β}_{0} + {β}_{0} + {β}_{1} {x}_{1} + … + {β}_{d} {x}_{d} ,$$

where xᵢs for 1≤i≤d are for the customer traits in the vector x and βᵢs for 0≤i≤d are the coefficients of the logistic regression learned from the customer's traits. Expressed in terms of the probability score—

$$p ( x ) = \frac{1}{1 + exp ( - ( {β}_{0} + {β}_{1} {x}_{1} + … + {β}_{d} {x}_{d} ) )} .$$

Returning to the example of calculating the probability score that Customerₓ purchases Item_{y}, and assuming that (β₀, . . . , β₅)=(−0.1, 0.3, −0.4, 0.7, −0.5, 0.6) are the coefficients of the logistic regression model M learned from the data, Customerₓ's feature vector is described by X_{Customer}_{ₓ}=(5.5, 2.5, 3.0, 4.5, 1.0)^{T} where the superscript T indicates that the vector is a column vector, the probability score is calculated by the equation—

$$p ( x ) = \frac{1}{1 + exp ( - ( - 0.1 + 0.3 {x}_{1} - 0.4 {x}_{2} + 0.7 {x}_{3} - 0.5 {x}_{4} + 0.6 {x}_{5} ) )} .$$

Inserting Customerₓ's feature vector provided above with respect to Customerₓ and Item_{y}, the equation becomes—

$$p ( x ) = \frac{1}{\begin{matrix}1 + exp ( - ( - 0.1 + 0.3 * 5.5 - \\ 0.4 * 2.5 + 0.7 * 3 - 0.5 * 4.5 + 0.6 * 1. ) )\end{matrix}} = 0.73 .$$

Accordingly, the probability score that Customerₓ will purchase Item_{y} is 0.73 (i.e., p(x)=0.73).

In a simple embodiment, the control circuit 302 provides samples to the customers based on the probability scores calculated for the customers with respect to the items. For example, the control circuit 302 can select a number of samples (e.g., 1, 2, 3, etc.) for each customer having the highest probability score, those samples having a probability score above a threshold, etc. It should be noted that in some circumstances, sufficient data for a customer may not be available to calculate probability scores for the customer. For example, a new customer may not have any purchase and/or browsing histories, a customer that shops infrequently may have little in the way of purchase and/or browsing histories, etc. In such cases, the probability scores can be based on global averages (e.g., all customers) or a subset of customers (e.g., those customers with data similar to that of the subject customer).

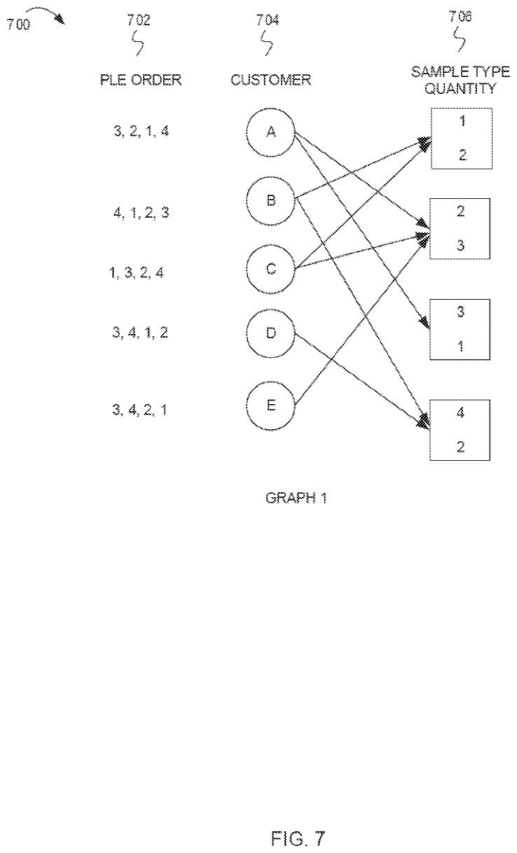

In some embodiments, sample quantities may be limited or the probability scores for customers with respect to samples may require the provision of a greater number of samples than available. In such embodiments, the personalized sample selector 306 can distribute the samples amongst the customers. For example, in one embodiment, the personalized sample selector 306 can distribute the samples in such a manner as to decrease customer dissatisfaction with the samples provided. This analysis can be depicted, for example, using the bipartite graph 700 depicted in FIG. 7 (i.e., Graph 1);

The bipartite graph 700 (i.e., Graph 1) depicted above includes three columns: 1) a PLE Order column 702, 2) a Customer column 704, and 3) Sample Type/Quantity column 706. The PLE Order column 702 represents the preference order of the sample for a customer based on the probability scores, the Customer column 704 represents customers, and the Sample Type/Quantity column 706 represents the sample type and quantity of samples of each type. In Graph 1, there are five customers (i.e., Customer_{A}, Customer_{B}, Customer_{C}, Customer_{D}, and Customer_{E}). It should be noted that Graph 1 includes only five customers for the sake of simplicity and that, in some embodiments, greater or fewer customers can be considered. In Graph 1, there are four sample types, each having a quantity of available samples of the type (i.e., Sample₁ has a quantity of two, Sample₂ has a quantity of three, Sample₃ has a quantity of one, and Sample₄ has a quantity of two. It should be noted that Graph 1 includes only four sample types for ease of discussion and that, in some embodiments, greater or fewer samples can be considered.

As discussed above, the PLE Order column 702 represents the order in which the samples should be provided to customers. For example, Customer_{A} has a PLE order of 3, 2, 1, 4. That is, based on the probability scores for Customer_{A} associated with Sample₁, Sample₂, Sample₃, and Sample₄, the sample should be provided to the customer, if possible, in the following order: Sample₃, Sample₂, Sample₁, and finally Sample₄. That is, the customer's probability score for Sample₃ is greater than the customer's probability score for Sample₂, the customer's probability score for Sample₂ is greater than the customer's probability score for Sample₁, and the customer's probability score for Sample₁ is greater than the customer's probability score for Sample₄.

As can be seen, conflicts arise when an attempt is made to provide each customer with his or her preferred sample (i.e., the sample for which the probability score is highest for each customer). For example, Customer_{A} and Customer_{D} both have the same preferred sample (i.e., Sample₃) but there is only one item of Sample₃ available. Consequently, Sample; cannot be provided to both Customer_{A} and Customer_{D}. The personalized sample selector 306 seeks to distribute these limited samples amongst the customers. In one embodiment, the personalized sample selector 306 manages this problem by distributing the samples in such a way that the overall sum of probability scores is maximized. That is, the personalized sample selector 306 distributes the samples based on the following formula—

Σᵢ₌₁^{k} Probability Score=Maximum,

where k represents a number of customers. For example, as represented by the arrows in Graph 1, Customer_{A} receives Sample₃ and Sample₂, Customer_{B} receives Sample₄ and Sample₁, Customer_{C} receives Sample₁ and Sample₂, Customer_{D} receives Sample₄, and Customer_{E} receives Sample₂. In some embodiments, as samples are distributed to customers, the personalized sample selector 306 can update the quantities of the samples in the database 314.

In some embodiments, as discussed with respect to FIG. 2, customers are presented with selecting a number of the samples provided to him or her. For example, the customer may be presented with Y samples and asked to select X of the Y samples. In this example, X<Y, X≤Y, or X=Y, based on the desired implementation. In such embodiments, the Y samples can be selected for presentation to the customer based on the probability scores. For example, the customer can be presented with all samples having a probability score above a threshold, the Y highest ranking samples based on the probability scores, etc. Additionally, or alternatively, the Y samples, and number X, can be selected based on the availability of samples (e.g., the quantity of available for each available sample type).

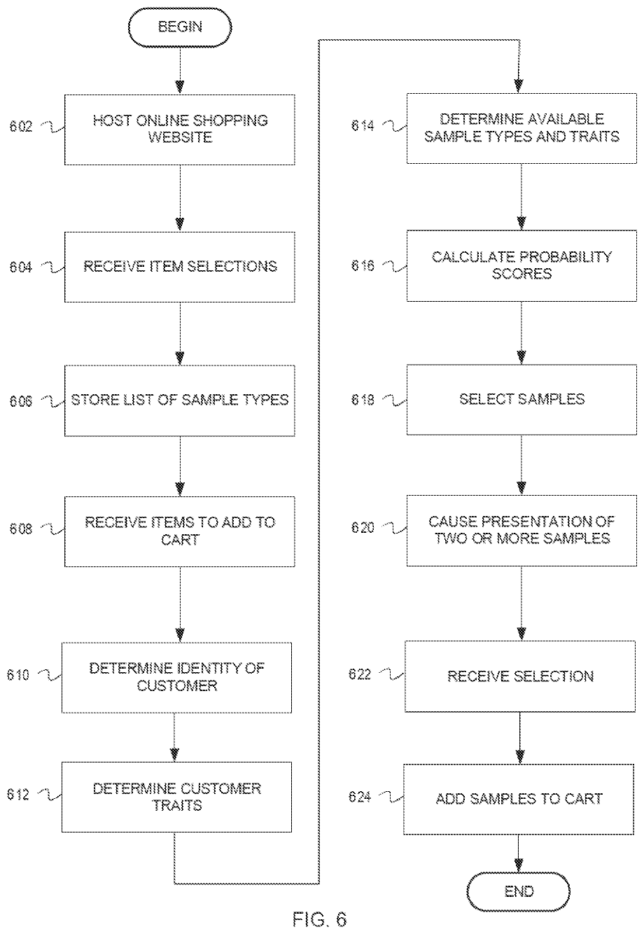

In some embodiments, the customer is presented with a number of samples from which he or she can select. For example, the customer can be presented with Y samples and prompted to select up to X samples (i.e., select 0−X samples of the Y samples presented, where X≤Y), as discussed in more detail with respect to FIG. 6. In such embodiments, the personalized sample selector 306 can select the Y samples for the customer based, for example, on the probability scores calculated by the purchase likelihood estimator 304. That is, each of the Y samples can be selected based on their probability scores, resulting in samples being presented to the customer that are estimated to be likely selected by the customer. However, in some embodiments, the samples need not be selected solely based on the probability scores. For example, in some embodiments, the customer choice executor 308 can select the Y samples to include some samples that the customer is likely to purchase as well as some samples that are selected randomly from the pool of available samples. For example, if Y=5 and X=2 (i.e., the customer is presented with five samples and prompted to select up to two of the five samples offered), the customer choice executor 308 can select three samples that have high probability scores (e.g., the three samples having the highest probability scores) and two samples randomly from all of the available samples or a subset of all of the available samples. Though a customer may not ultimately select any of the samples selected randomly, such random selection of samples may act to inform the customer of other products offered by the retailer (e.g., products that the customer may not realize the retailer offers), prompt a customer to try and/or purchase a new product that he or she may not have otherwise purchased, etc.

Further, in some embodiments in which the customer is presented with a number of samples and asked to select from the number of samples, the presentation and/or selection by the customer may proceed in a number of rounds. That is, the customer may be presented with different samples during each round and asked to select from the samples provided in each round. For example, if the customer is ultimately prompted to select two samples, he or she may be presented with three samples in the first round. The first round can also include a selection to “refresh” the samples, bringing the customer to a second round. If the customer selects fewer than two samples in the first round, he or she is presented with a second round of samples. For example, if the customer selects only one sample in the first round, he or she may be presented with two more samples from which to select in the second round. If the customer selects a second sample in the second round, the two samples selected from the two rounds are added to the customer's cart. However, if the customer has not selected his or her allotted number of samples (i.e., two total samples in this example), the customer may be presented with additional samples in further rounds until he or she has selected his or her allotted number of samples or declined to select additional samples. In some embodiments, the samples provided to the customer in each round can be based on previous rounds. For example, if the customer selects one sample in the first round, the samples in the second round can be chosen for the customer based on the sample selected in the first round (e.g., similar samples, complementary samples, etc.). As noted previously, if the customer does not select any of the samples, no samples will be added to the customer's cart. Further, in some embodiments, selection of samples by a customer can be more complex than simply clicking on a sample. For example, in some embodiments, the customer may be asked to solve a simple puzzle (e.g., a simple mathematical problem, a logic problem, etc.) to select one of the samples. In some forms, puzzles can be used that provide value to a retailer. For example, customers may be presented with images including text and asked to enter the text in order to select a sample. Such input by customers can be used by the retailer for text extraction algorithms.

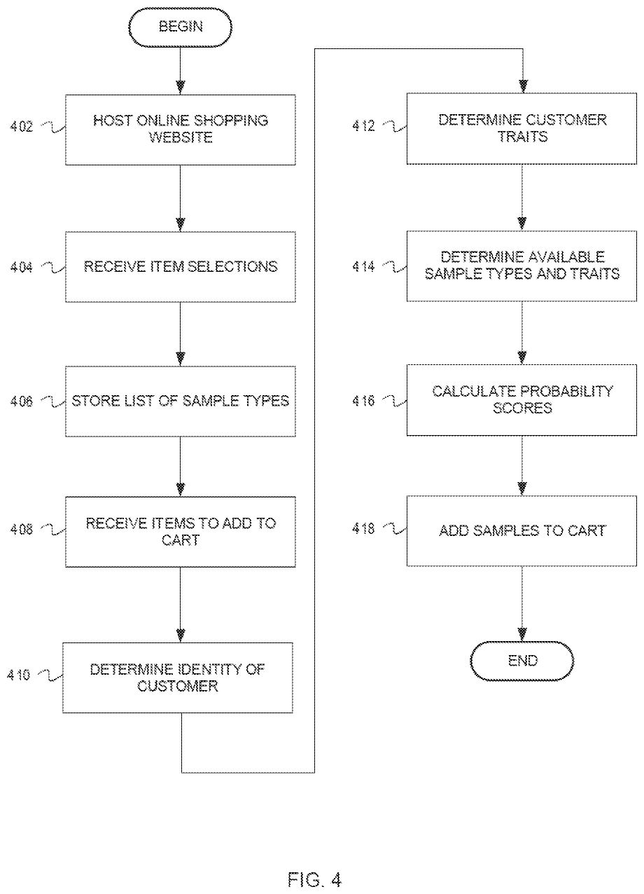

While the discussion of FIG. 3 provides additional detail regarding a system for providing samples to customers based on probability scores, the discussion of FIGS. 4-6 describe example operations of such a system. With respect to FIG. 4, discussion is provided regarding selecting samples for customers based on calculated probability scores for the samples.

FIG. 4 is a flow chart including example operations for providing personalized samples to customers, according to some embodiments. The flow begins at block 402.

At block 402, an online shopping website is hosted. For example, an online shopping server can host the online shopping website. The online shopping website allows the customer to browse and select items for purchase. The flow continues at block 404.

At block 404, item selections are received. For example, the online shopping server can receive item selections from the customers via the online shopping website. While shopping, the customers select items to add to his or her cart. That is, the online shopping website receives item selections from the customers. The flow continues at block 406.

At block 406, a list of sample types is stored. For example, a database can store the list of sample types. The list of sample types can include any suitable information with respect to the samples. For example, the list of samples can include types of the samples, quantities of the samples, traits associated with the samples (e.g., item categories, item prices, item relationships, complementary items, substitute items, etc.), availability of the samples, etc. the flow continues at block 408.

At block 408, the items to add to the customer's cart are received. For example, a control circuit can receive the items to add to the customer's cart from the online shopping server. In some embodiments, a purchase likelihood estimator receives the items to add to the customer's cart. The items to add to the customer's cart were selected by the customer while he or she shopped. The flow continues at block 410.

At block 410, an identity of the customer is determined. For example, the control circuit can determine the identity of the customer. In some embodiments, the purchase likelihood estimator can determine the identity of the customer. The identity of the customer can be an identity of a specific customer (e.g., the customer's name, account number, etc.) or can more generically identify customers (e.g., the identity of the customer may not identify the specific customer, but may rather identify the customer based on a shopping session, internet protocol (IP) address, etc. such that the customer is simply a customer with which the items to add to the cart are associated but it is not know the actual identity of the customer). In an account-based system, the customer may be specifically identified. For example, when the customer created his or her account, he or she may have provided identifying information such as his or her name, address, phone number, payment methods, preferences, etc. In such a system, the customer can be identified based on his or her account. In a non-account-based system, the customer may still be able to be identified. For example, the customer may provide identifying information at the beginning of, end of, or during his or her shopping session. However, as noted above, the specific identity of the customer may not be necessary. For example, if the customer does not have an account, he or she may continue as a “guest.” When doing so, the customer's cart may be generated based on other identifiers that are not the specific identity of the customer (e.g., IP address, media access control (MAC) address, browsing session, etc.). The flow continues at block 412.

At block 412, customer traits are determined. For example, the control circuit can determine the customer traits for the customer based on the identity of the customer. In some embodiments, the purchase likelihood estimator determines the customer traits. The customer traits can include any desired information about the customer, such as the customer's purchase history (e.g., online and/or in-store purchase history), the customer's browsing history, the items to add to the customer's cart, etc. In some embodiments, the database may also store the customer traits. For example, in an account-based system, the database can store customer identities as well as customer traits for the customers. The flow continues at block 414.

At block 414, available sample types and traits associated with the available sample types are determined. For example, the control circuit can determine the available sample types and traits associated with the available sample types based on accessing the database. In some embodiments, the purchase likelihood estimator determines the available sample types and traits associated with the available sample types. The flow continues at block 416.

At block 416, probability scores are calculated. For example, the control circuit can calculate the probability scores. In some embodiments, the purchase likelihood estimator calculates the probability scores. The probability scores are calculated for each of the available sample types for the customer. The probability scores are based on the customer traits and the traits associated with each of the available sample types. The probability scores indicate a likelihood that the customer will purchase an item of each of the sample types. The control circuit can calculate the probability scores based on any suitable algorithm and/or metric. For example, the control circuit can calculate the probability scores based on penalized-logistic regression models, gradient boosting, random forest and feed-forward neural network models, etc. The flow continues at block 418.

At block 418, samples are added to the customer's cart. For example, the control circuit can add the samples to the customer's cart. In some embodiments, the purchase likelihood estimator adds the samples to the customer's cart. The control circuit adds one or more samples of the available sample types to the customer's cart based on the probability scores. For example, the control circuit can select and add the two samples having the highest probability score, all samples having a probability score above a threshold, the sample with the greatest quantity having the highest probability score, etc. In some embodiment, additional and/or different factors can be considered when samples are selected. For example, in some embodiments, samples can be selected based on the items in the customer's cart. The samples can be selected as complementing the items in the customer's cart, competing with the items in the customer's cart, etc. In such embodiments, the samples can be added to the customer's cart based on the probability score and whether the item is complementary or competitive. Additionally, in some embodiments, if more than one sample is provided, the samples can be selected to have differing types or a same type.

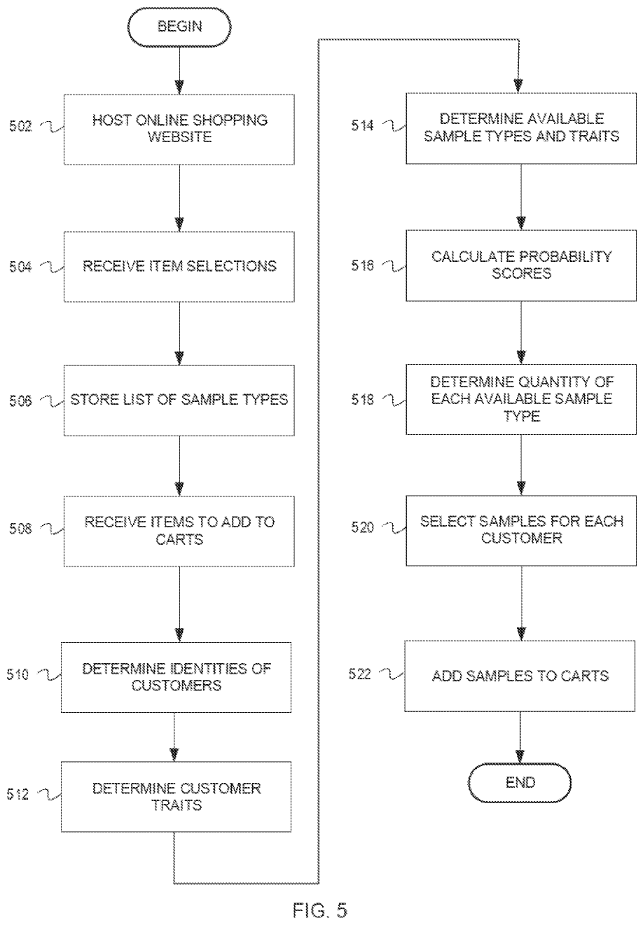

While the discussion of FIG. 4 describes selecting samples for customers based on calculated probability scores for the samples, the discussion of FIG. 5 describes selecting samples for customers based on probability scores and the quantity of each of the samples available.

FIG. 5 is a flow chart including example operations for providing personalized samples to customers, according to some embodiments. The flow begins at block 502.

At block 502, an online shopping website is hosted. For example, an online shopping server can host the online shopping website. The online shopping website allows the customer to browse and select items for purchase. The flow continues at block 504.

At block 504, item selections are received. For example, the online shopping server can receive item selections from the customers via the online shopping website. While shopping, the customers select items to add to his or her cart. That is, the online shopping website receives item selections from the customers. The flow continues at block 506.

At block 506, a list of sample types is stored. For example, a database can store the list of sample types. The list of sample types can include any suitable information with respect to the samples. For example, the list of samples can include types of the samples, quantities of the samples, traits associated with the samples (e.g., item categories, item prices, item relationships, complementary items, substitute items, etc.), availability of the samples, etc. the flow continues at block 508.

At block 508, the items to add to the customers' carts are received. For example, a control circuit can receive the items to add to the customers' carts from the online shopping server. In some embodiments, a purchase likelihood estimator can receive the items to add to the customers' carts. The items to add to the customers' carts were selected by the customers while they shopped. The flow continues at block 510.

At block 510, identities of the customers are determined. For example, the control circuit can determine the identities of the customers. In some embodiments, the purchase likelihood estimator determines the identities of the workers. The identities of the customers can be an identity of a specific customer (e.g., the customer's name, account number, etc.) or can more generically identify customers (e.g., the identity of the customer may not identify the specific customer, but may rather identify the customer based on a shopping session, internet protocol (IP) address, etc. such that the customer is simply a customer with which the items to add to the cart are associated but it is not know the actual identity of the customer). In an account-based system, the customer may be specifically identified. For example, when the customer created his or her account, he or she may have provided identifying information such as his or her name, address, phone number, payment methods, preferences, etc. In such a system, the customer can be identified based on his or her account. In a non-account-based system, the customer may still be able to be identified. For example, the customer may provide identifying information at the beginning of, end of, or during his or her shopping session. However, as noted above, the specific identity of the customer may not be necessary. For example, if the customer does not have an account, he or she may continue as a “guest.” When doing so, the customer's cart may be generated based on other identifiers that are not the specific identity of the customer (e.g., IP address, media access control (MAC) address, browsing session, etc.). The flow continues at block 512.

At block 512, customer traits are determined. For example, the control circuit can determine the customer traits for each of the customers based on the identities of the customers. In some embodiments, the purchase likelihood estimator determines the customer traits. The customer traits can include any desired information about the customer, such as the customer's purchase history, the customer's browsing history, the items to add to the customer's cart, etc. In some embodiments, the database may also store the customer traits. For example, in an account-based system, the database can store customer identities as well as customer traits for the customers. The flow continues at block 514.

At block 514, available sample types and traits associated with the available sample types are determined. For example, the control circuit can determine the available sample types and traits associated with the available sample types based on accessing the database. In some embodiments, the purchase likelihood estimator can determine the available sample types and the traits associated with the available sample types. The flow continues at block 516.

At block 516, probability scores are calculated. For example, the control circuit can calculate the probability scores. In some embodiments, the purchase likelihood estimator calculates the probability scores. The probability scores are calculated for each of the available sample types for each of the customers. The probability scores are based on the customer traits and the traits associated with each of the available sample types. The probability scores indicate a likelihood that the customer will purchase an item of each of the sample types. The control circuit can calculate the probability scores based on any suitable algorithm and/or metric. For example, the control circuit can calculate the probability scores based on penalized-logistic regression models, gradient boosting, random forest and feed-forward neural network models, etc. The flow continues at block 518.

At block 518, the quantity of each of the available sample types is determined. For example, the control circuit can determine the quantity of each of the available sample types. In some embodiments, a personalized sample selector determines the quantity of each of the available sample types. The control circuit determines the quantity of each of the available sample types based on accessing the database. The flow continues at block 520.

At block 520, samples are selected for each of the customers. For example, the control circuit can select the samples for each of the customers. In some embodiments, the personalized sample selector selects the samples for each of the customers. The control circuit selects the samples for each of the customers based on the probability scores and the quantity of each of the available sample types. The control circuit selects the samples for each of the customers in a manner that attempts to minimize customer dissatisfaction or disappointment. As one example, the control circuit selects the samples for the customers such that the sum of probability scores is maximized. The flow continues at block 522.

At block 522, the samples are added to the customers' carts. For example, the control circuit can add the samples to the customers' carts. In some embodiments, the purchase likelihood estimator or the personalized sample selector adds the samples to the customer's carts. In some embodiment, additional and/or different factors can be considered when samples are selected. For example, in some embodiments, samples can be selected based on the items in the customer's cart. The samples can be selected as complementing the items in the customer's cart, competing with the items in the customer's cart, etc. In such embodiments, the samples can be added to the customer's cart based on the probability score and whether the item is complementary or competitive. Additionally, in some embodiments, if more than one sample is provided, the samples can be selected to have differing types or a same type.

While the discussion of FIG. 5 describes selecting samples for customers based on probability scores and the quantity of each of the samples available, the discussion of FIG. 6 describes selecting samples for a customer from which the customer can choose.

FIG. 6 is a flow chart including example operations for providing personalized samples to customers, according to some embodiments. The flow begins at block 602.

At block 602, an online shopping website is hosted. For example, an online shopping server can host the online shopping website. The online shopping website allows the customer to browse and select items for purchase. The flow continues at block 604.

At block 604, item selections are received. For example, the online shopping server can receive item selections from the customers via the online shopping website. While shopping, the customers select items to add to his or her cart. That is, the online shopping website receives item selections from the customers. The flow continues at block 606.

At block 606, a list of sample types is stored. For example, a database can store the list of sample types. The list of sample types can include any suitable information with respect to the samples. For example, the list of samples can include types of the samples, quantities of the samples, traits associated with the samples (e.g., item categories, item prices, item relationships, complementary items, substitute items, etc.), availability of the samples, etc. the flow continues at block 608.

At block 608, the items to add to the customer's cart are received. For example, a control circuit can receive the items to add to the customer's cart from the online shopping server. In some embodiments, a purchase likelihood estimator receives the items to add to the customer's cart. The items to add to the customer's cart were selected by the customer while he or she shopped. The flow continues at block 610.

At block 610, an identity of the customer is determined. For example, the control circuit can determine the identity of the customer. In some embodiments, the purchase likelihood estimator can determine the identity of the customer. The identity of the customer can be an identity of a specific customer (e.g., the customer's name, account number, etc.) or can more generically identify customers (e.g., the identity of the customer may not identify the specific customer, but may rather identify the customer based on a shopping session, internet protocol (IP) address, etc. such that the customer is simply a customer with which the items to add to the cart are associated but it is not know the actual identity of the customer). In an account-based system, the customer may be specifically identified. For example, when the customer created his or her account, he or she may have provided identifying information such as his or her name, address, phone number, payment methods, preferences, etc. In such a system, the customer can be identified based on his or her account. In a non-account-based system, the customer may still be able to be identified. For example, the customer may provide identifying information at the beginning of, end of, or during his or her shopping session. However, as noted above, the specific identity of the customer may not be necessary. For example, if the customer does not have an account, he or she may continue as a “guest.” When doing so, the customer's cart may be generated based on other identifiers that are not the specific identity of the customer (e.g., IP address, media access control (MAC) address, browsing session, etc.). The flow continues at block 612.

At block 612, customer traits are determined. For example, the control circuit can determine the customer traits for the customer based on the identity of the customer. In some embodiments, the purchase likelihood estimator determines the customer traits. The customer traits can include any desired information about the customer, such as the customer's purchase history, the customer's browsing history, the items to add to the customer's cart, etc. In some embodiments, the database may also store the customer traits. For example, in an account-based system, the database can store customer identities as well as customer traits for the customers. The flow continues at block 614.

At block 614, available sample types and traits associated with the available sample types are determined. For example, the control circuit can determine the available sample types and traits associated with the available sample types based on accessing the database. In some embodiments, the purchase likelihood estimator determines the available sample types and traits associated with the available sample types. The flow continues at block 416.

At block 616, probability scores are calculated. For example, the control circuit can calculate the probability scores. In some embodiments, the purchase likelihood estimator calculates the probability scores. The probability scores are calculated for each of the available sample types for the customer. The probability scores are based on the customer traits and the traits associated with each of the available sample types. The probability scores indicate a likelihood that the customer will purchase an item of each of the sample types. The control circuit can calculate the probability scores based on any suitable algorithm and/or metric. For example, the control circuit can calculate the probability scores based on penalized-logistic regression models, gradient boosting, random forest and feed-forward neural network models, etc. The flow continues at block 618.

At block 618, samples are selected. For example, the control circuit can select the samples. In some embodiments, a customer choice executor selects the samples. The control circuit selects the samples based on the probability scores. The control circuit selects two or more samples from which the customer can choose a number of samples. In some embodiment, additional and/or different factors can be considered when samples are selected. For example, in some embodiments, samples can be selected based on the items in the customer's cart. The samples can be selected as complementing the items in the customer's cart, competing with the items in the customer's cart, etc. In such embodiments, the samples can be added to the customer's cart based on the probability score and whether the item is complementary or competitive. Additionally, in some embodiments, if more than one sample is provided, the samples can be selected to have differing types or a same type. The flow continues at block 620.

At block 620, presentation of the samples is caused. For example, the control circuit can cause presentation of the samples via a display device of a user device, as discussed with respect to FIG. 3. The sample are presented to the customer. For example, the control circuit can cause presentation of five selected samples. Additionally, the presentation can request the customer to make a selection from the presented samples. Continuing the example provided above, the presentation can request the customer to select two of the five samples provided. The flow continues at block 622.

At block 622, a selection is received. For example, the control circuit can receive the selection from the customer via a user input device of the user device. In some embodiments, the customer choice executor receives the selection from the customer. The selection selects samples from those presented. Continuing the example above, the control circuit receives selection of the two samples from the five samples provided. In some embodiments, the customer may not be required to select a specific number of samples, if any. For example, if the customer is presented with five samples and asked to pick two of the samples, the customer may be permitted to select zero, one, or two of the samples. The flow continues at block 624.

At block 624, samples are added to the customer's cart. For example, the control circuit can add the samples selected by the customer to the customer's cart. In some embodiments, the purchase likelihood estimator of the customer choice executor can add the samples to the customer's cart. Continuing the example provided above, if the customer selected two of the five sample, the control circuit adds the two selected samples to the customer's cart.

Though the actions of the purchase likelihood estimator, personalized sample selector, and customer choice executor are described herein as operating independently of one another, this is done for the ease of explanation and such is not required. That is, in some embodiments, two or more of the purchase likelihood estimator, personalized sample selector, and customer choice executor can operate to add samples to the customer's cart or customers' carts. For example, in some embodiments, the purchase likelihood estimator calculates probability scores, the personalized sample selector analyzes the distribution of a limited number of samples, and the customer choice executor allows customers to select from the samples offered.

Though the provision of samples discussed herein is done online, embodiments are not so limited. In some embodiments, the teachings provided herein can be adapted for use in an in-store setting. That is, the different components described herein can act to provide customers with samples in a retail facility. For example, the retail facility may include a kiosk or other station at which the customer can receive samples. In such embodiments, personalized samples are selected for the customers, as described above with respect to the purchase likelihood estimator, personalized sample selector, and/or customer choice executor based on the likelihood that a customer will ultimately purchase the item for which a sample is provided. When the customer checks out (i.e., purchases his or her items), a code (e.g., a 2D or 3D barcode) can be printed on the customer's receipt. The code is indicative of the samples for the customer (e.g., linked to an entry in a database that includes indications of the samples). In the kiosk-based embodiment, the customer can scan the code at the kiosk to receive the samples. Additionally, or alternatively, the customer may receive the samples at checkout or receive the samples from a service counter.

In some embodiments, a system for providing personalized samples to customers comprises an online shopping server, wherein the online shopping server is configured to host an online shopping website and receive, from a customer, item selections, wherein the item selections indicate items to add to the customer's cart, a database, wherein the database is configured to store a list of sample types, and a purchase likelihood estimator communicatively coupled to the online shopping server, the purchase likelihood estimator configured to receive, from the online shopping server, the items to add to the customer's cart, determine an identity of the customer, determine, based on the identity of the customer, customer traits, wherein the customer traits are based on one or more of the customer's purchase history, the customer's browsing history, and the items to add to the customer's cart, determine, based on accessing the database, available sample types and traits associated with the available sample types, calculate, for each of the available sample types, a probability score, wherein the probability score is based on the customer traits and the traits associated with each of the available sample types, and wherein the probability score indicates a likelihood that the customer will purchase an item of each of the available sample types, and add, to the customer's cart based on the probability scores for each of the available sample types, one or more samples from the one or more of the available sample types.

In some embodiments, an apparatus and a corresponding method performed by the apparatus comprises hosting, by an online shopping server, an online shopping website, receiving, by the online shopping server from a customer, item selections, wherein the item selections indicate items to add to the customer's cart, storing, in a database, a list of sample types, receiving, from the online shopping server by a purchase likelihood estimator, the items to add to the customer's cart, determining, by the purchase likelihood estimator, an identity of the customer, determining, by the purchase likelihood estimator based on the identity of the customer, customer traits, wherein the customer traits are based on one or more of the customer's purchase history, the customer's browsing history, and the items to add to the customer's cart, determining, by the purchase likelihood estimator based accessing the database, available sample types and traits associated with the available sample types, calculating, by the purchase likelihood estimator for each of the available sample types, a probability score, wherein the probability score is based on the customer traits and the traits associated with each of the available sample types, and wherein the probability score indicates a likelihood that the customer will purchase an items of each of the sample types, and adding, by the purchase likelihood estimator to the customer's cart based on the probability scores for each of the sample types, one or more samples from the one or more of the available sample types.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

1. A system for providing personalized samples to customers, the system comprising:
an online shopping server, wherein the online shopping server is configured to:
host an online shopping website; and
receive, from a customer, item selections, wherein the item selections indicate items to add to the customer's cart;
a database, wherein the database is configured to store a list of sample types; and
a purchase likelihood estimator communicatively coupled to the online shopping server, the purchase likelihood estimator configured to:
receive, from the online shopping server, the items to add to the customer's cart;
determine an identity of the customer;
determine, based on the identity of the customer, customer traits, wherein the customer traits are based on one or more of the customer's purchase history, the customer's browsing history, and the items to add to the customer's cart;
determine, based on accessing the database, available sample types and traits associated with the available sample types;
calculate, for each of the available sample types, a probability score, wherein the probability score is based on the customer traits and the traits associated with each of the available sample types, and wherein the probability score indicates a likelihood that the customer will purchase an item of each of the sample types; and
add, to the customer's cart based on the probability scores for each of the sample types, one or more samples from the one or more of the available sample types.

2. The system of claim 1, wherein the purchase likelihood estimator is a module of a control circuit, and wherein the purchase history includes online purchase history and in-store purchase history.

3.-4. (canceled)

5. The system of claim 1, wherein the purchase likelihood estimator is further configured to:
receive, from the customer via a user interface, an indication that the customer would not like a first sample of the one or more samples from the one or more of the available sample types added to the customer's cart; and
remove, from the customer's cart, the first sample.

6. The system of claim 1, wherein the purchase likelihood estimator selects the one or more samples from the one or more of the available sample types based on the one or more samples from the one or more of the available sample types having a highest probability score.

7. The system of claim 1, wherein the purchase likelihood estimator in adding the one or more samples to the customer's cart adds a first sample of the one or more samples as a complement to at least one of the items to add to the customer's cart.

8. The system of claim 1, wherein the purchase likelihood estimator in adding the one or more samples to the customer's cart adds a first sample of the one or more samples that competes with at least one of the items to add to the customer's cart.

9. (canceled)

10. The system of claim 1, wherein the purchase likelihood estimator calculates the probability score based on an equation, wherein the equation comprising:
Probability Scoreₓ=Pr(B=1|X=x)
wherein the Probability Scoreₓ represents a likelihood that the customer will buy a sample from category X, wherein Pr is a function of B and X, wherein B represents a Boolean value, and wherein X represents at least one of the customer's traits.

11. A method for providing personalized samples to customer, the method comprising:
hosting, by an online shopping server, an online shopping website;
receiving, by the online shopping server from a customer, item selections, wherein the item selections indicate items to add to the customer's cart;
storing, in a database, a list of sample types;
receiving, from the online shopping server by a purchase likelihood estimator, the items to add to the customer's cart;
determining, by the purchase likelihood estimator, an identity of the customer;
determining, by the purchase likelihood estimator based on the identity of the customer, customer traits, wherein the customer traits are based on one or more of the customer's purchase history, the customer's browsing history, and the items to add to the customer's cart;
determining, by the purchase likelihood estimator based on accessing the database, available sample types and traits associated with the available sample types;
calculating, by the purchase likelihood estimator for each of the available sample types, a probability score, wherein the probability score is based on the customer traits and the traits associated with each of the available sample types, and wherein the probability score indicates a likelihood that the customer will purchase an item of each of the sample types; and
adding, by the purchase likelihood estimator to the customer's cart based on the probability scores for each of the sample types, one or more samples from the one or more of the available sample types.

12. The method of claim 11, wherein the purchase likelihood estimator is a module of a control circuit, and wherein the purchase history includes online purchase history and in-store purchase history.

13.-14. (canceled)

15. The method of claim 11, further comprising:
receiving, by the purchase likelihood estimator from the customer via a user interface, an indication that the customer would not like a first sample of the one or more samples from the one or more of the available sample types added to the customer's cart; and
removing, by the purchase likelihood estimator from the customer's cart, the first samples.

16. The method of claim 11, wherein the purchase likelihood estimator selects the one or more samples from the one or more of the available sample types based on the one or more samples from the one or more of the available sample types having a highest probability score.

17. The method of claim 11, wherein the adding the one or more samples to the customer's cart comprises adding a first sample of the one or more samples as a complement to at least one of the items to add to the customer's cart.

18. The method of claim 11, wherein the adding the one or more samples to the customer's cart comprises adding a first sample of the one or more samples that competes with at least one of the items to add to the customer's cart.

19. (canceled)

20. The method of claim 11, wherein the purchase likelihood estimator calculates the probability score based on an equation, wherein the equation comprises:
Probability Scoreₓ=Pr(B=1|X=x)
wherein the Probability Scoreₓ represents a likelihood that the customer will buy a sample from category X, wherein Pr is a function of B and X, wherein B represents a Boolean value, and wherein X represents at least one of the customer's traits.

21. The system of claim 1, wherein:
the online shopping server is configured to:
receive, from multiple different customers, item selections, wherein the item selections indicate items to add to respective customers' carts, comprising receiving the item selections from the customer;
the purchase likelihood estimator is further configured to calculate, for each of the available sample types and for each of the multiple different customers, multiple probability scores, wherein the multiple probability scores are based on respective traits of the multiple different customers and the traits associated with each of the available sample types, and wherein the multiple probability scores indicate a respective likelihood that each of the multiple different customers will purchase an item of each of the sample types; and
a personalized sample selector configured to:
determine, based on accessing the database, a quantity of each of the available sample types; and
select, based on the multiple probability scores and the quantity of each of the available sample types, a respective set of at least one sample from the one or more of the available sample types for each of the different customers, wherein the selection is based on maximizing a sum of the probability scores; and
wherein the purchase likelihood estimator, in adding the one or more samples to the customer's cart, is configured to add, to the respective customers' carts based on the selection, the respective set of at least one sample from the one or more of the available sample types for each of the multiple different customers.

22.-23. (canceled)

24. The system of claim 21, wherein the personalized sample selector selects the one or more samples from the one or more of the available sample types based on one or more of penalized-logistic regression models, gradient boosting, random forest, and feed-forward neural network models.

25.-29. (canceled)

30. The system of claim 21, wherein the personalized sample selector, in selecting the one or more samples for each of the customers is determined based on an equation, wherein the equation comprises:
$${\sum }_{i = 1}^{k} Probability Score = Maximim$$
wherein k represents a number of customers.

31. The method of claim 11, wherein:
the calculating the probability score comprises calculating, by the purchase likelihood estimator for each of the available sample types for each of multiple different customers, multiple probability scores, wherein the multiple probability scores are based on respective traits of the multiple different customers' and the traits associated with each of the available sample types, and wherein the multiple or probability scores indicate a likelihood that each of the multiple different customers will purchase an item of each of the sample types;
determining, by a personalized sample selector based on accessing the database, a quantity of each of the available sample types; and
selecting, based on the multiple probability scores and the quantity of each of the available sample types, the one or more samples from the one or more of the available sample types for each of the multiple different customers, wherein the selection is based on maximizing a sum of the probability scores.

32.-33. (canceled)

34. The method of claim 31, wherein the personalized sample selector selects the one or more samples from the one or more of the available sample types based on one or more of penalized-logistic regression models, gradient boosting, random forest, and feed-forward neural network models.

35.-40. (canceled)

41. The system of claim 1, further comprising:
a customer choice executor configured to:
select, based on the probability scores for each of the sample types, multiple samples;
cause presentation, via a display device to the customer, of the multiple samples; and
receive, via a user interface from the customer, a selection of at least one of the multiple samples;
wherein the purchase likelihood estimator, in adding the one or more samples to the customer's cart, is further configured to:
add, to the customer's cart, at least the selected at least one of the multiple samples.

42.-43. (canceled)

44. The system of claim 41, wherein each of the multiple samples have different types.

45.-49. (canceled)

50. The method of claim 11, further comprising:
selecting, by a customer choice executor based on the probability scores for each of the sample types, multiple samples;
causing presentation, by the customer choice executor via a display device to the customer, of the multiple samples;
receiving, at the customer choice executor via a user interface from the customer, a selection of at least one of the multiple samples; and
wherein the adding the one or more samples to the customer's cart comprises adding to the customer's cart at least the selected at least one of the multiple samples.

51.-58. (canceled)
